(19) United States
(12) Patent Application Publication
(10) Pub. No.: US 2026/0045746 A1
(43) Pub. Date: Feb. 12, 2026

(54) Central Terminal, Coaxial Connector, Connector Assembly And Terminal Manufacturing Method

(71) Applicants: Tyco Electronics (Shanghai) Co., Ltd., Shanghai (CN); Tyco Electronics Technology (SIP) Co., Ltd., Suzhou (CN)

(72) Inventors: Xiandong (Pope) Zhang, Suzhou (CN); Jianjia Qi, Shanghai (CN); Feng (Carlos) Pan, Suzhou (CN)

(73) Assignees: Tyco Electronics (Shanghai) Co., Ltd., Shanghai (CN); Tyco Electronics Technology (SIP) Co., Ltd., Suzhou (CN)

(21) Appl. No.: 19/294,547

(22) Filed: Aug. 8, 2025

(30) Foreign Application Priority Data
Aug. 9, 2024 (CN) 202411087944.7

(51) Int. Cl. H01R 24/38; H01R 13/03; H01R 13/04; H01R 43/16; H01R 103/00

(52) U.S. Cl. CPC H01R 24/38; H01R 13/03; H01R 13/04; H01R 43/16; H01R 2103/00

(57) ABSTRACT

A central terminal includes a first terminal component and a second terminal component. The first terminal component has a cylindrical shape, a first mating end, and a first connecting end axially opposite the first mating end. The second terminal component has a columnar shape, a second mating end, and a second connecting end axially opposite the second mating end. The second connecting end is inserted into and connected to the first connecting end. The first terminal component is an integrated stamped part made by stamping a single sheet of metal material. The second terminal component is an integrated stamped part made by stamping a single rod of metal material.

### CROSS-REFERENCE TO RELATED APPLICATION

This application claims the benefit of the filing date under 35 U.S.C. § 119 (a)-(d) of Chinese Patent Application No. CN 202411087944.7 filed on Aug. 9, 2024, the whole disclosure of which is incorporated herein by reference.

### FIELD OF THE INVENTION

The present invention relates to a central terminal and a method for manufacturing the central terminal, and relates to a coaxial connector including the central terminal, and a connector assembly including the coaxial connector.

### BACKGROUND OF THE INVENTION

In the prior art, a central terminal of a coaxial connector is typically a machined part. The central terminal has a first mating end and a second mating end axially opposite each other. The first mating end is cylindrical and is used for mating with an inserted first mating terminal, and the second mating end is columnar and is used for inserting into a second mating terminal. Such a machined central terminal has higher costs and lower manufacturing efficiency. In addition, in order to improve electrical contact performance, a noble metal layer is also required to be plated on an electrical contact surface of each of the first mating end and the second mating end. Since the electrical contact surface of the first mating end is located on an inner peripheral surface, it is difficult to plate the electrical contact surface separately. Therefore, in the prior art, the entire central terminal can only be immersed in a plating bath for plating the entire central terminal, which further increases costs.

### SUMMARY OF THE INVENTION

A central terminal includes a first terminal component and a second terminal component. The first terminal component has a cylindrical shape, a first mating end, and a first connecting end axially opposite the first mating end. The second terminal component has a columnar shape, a second mating end, and a second connecting end axially opposite the second mating end. The second connecting end is inserted into and connected to the first connecting end. The first terminal component is an integrated stamped part made by stamping a single sheet of metal material. The second terminal component is an integrated stamped part made by stamping a single rod of metal material.

### BRIEF DESCRIPTION OF DRAWINGS

The invention will now be described by way of example with reference to the accompanying figures, of which:

FIG. 1 is a perspective view of a coaxial connector according to an exemplary embodiment;

FIG. 2 is an axial cross-sectional view of the coaxial connector of FIG. 1;

FIG. 3 is an axial cross-sectional view of a shield shell of the coaxial connector of FIG. 1;

FIG. 4 is a perspective view of a central terminal of the coaxial connector of FIG. 1;

FIG. 5 is an axial cross-sectional view of the central terminal of FIG. 4;

FIG. 6 is an exploded view of the central terminal of FIG. 4; and

FIG. 7 is a perspective view of a first terminal component of the coaxial connector of FIG. 1 and a first conveying tape according to an exemplary embodiment.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

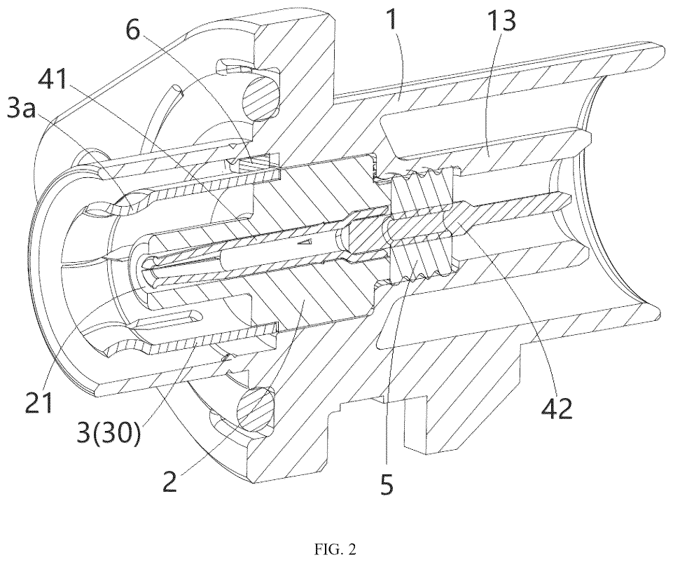

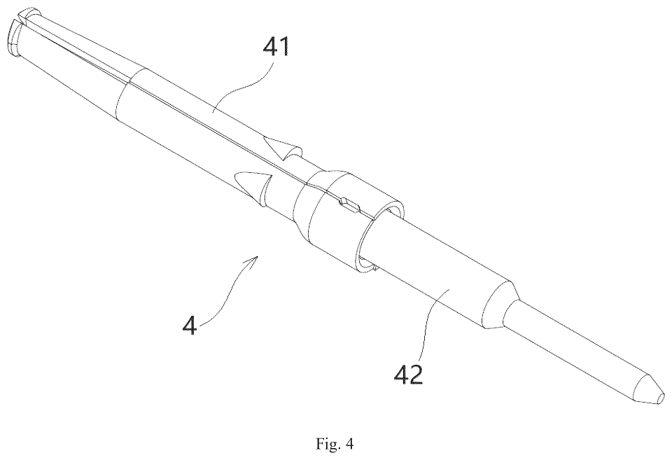

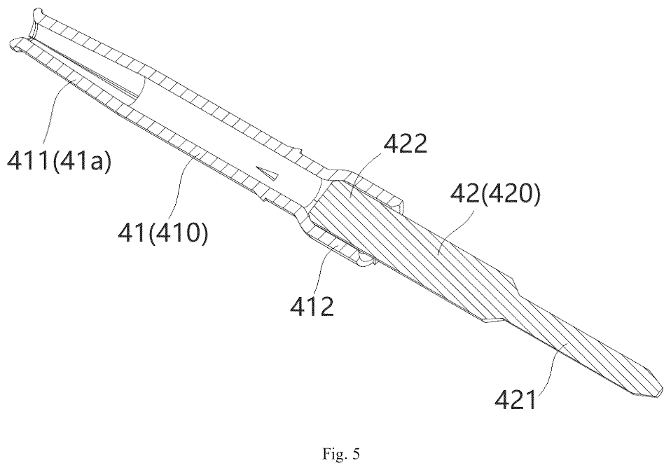

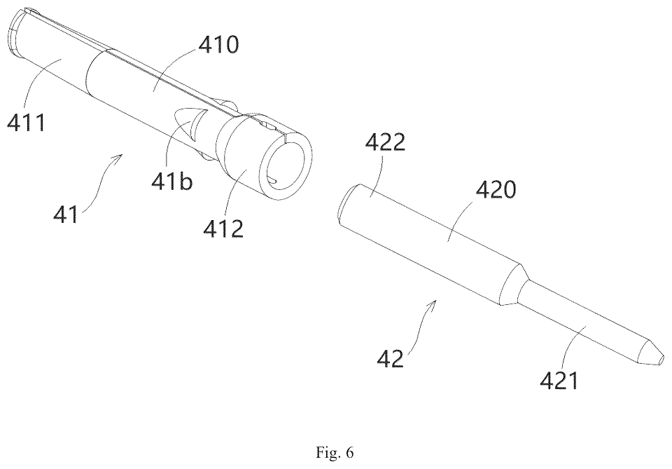

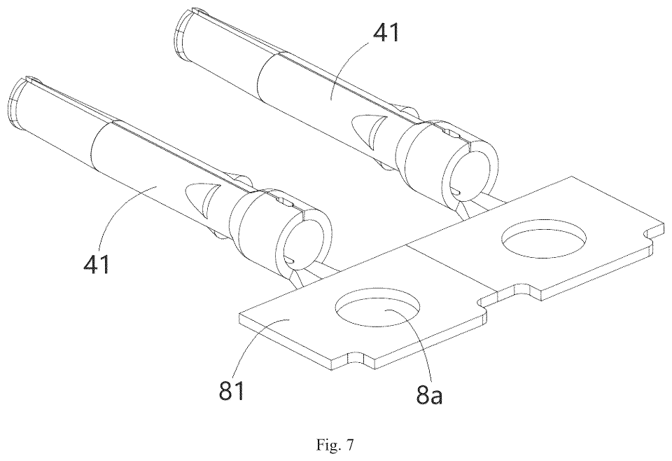

An exemplary embodiment of a central terminal 4 will now be described with reference to FIGS. 2 and 4-7. As shown in FIGS. 2, 4, and 6, the central terminal 4 includes a first terminal component 41 and a second terminal component 42. The first terminal component 41 is in the form of a hollow cylinder. As shown in FIGS. 5-6, the first terminal component 41 includes a first mating end 411 and a first connecting end 412 axially opposite each other. The second terminal component 42 is in the form of a solid column. The second terminal component 42, as shown in FIGS. 5-6, includes a second mating end 421 and a second connecting end 422 axially opposite each other. The second connecting end 422 of the second terminal component 42 is inserted into and connected to the first connecting end 412 of the first terminal component 41. The first terminal component 41 is an integrated stamped part made by stamping a single sheet of metal material, and the second terminal component 42 is an integrated stamped part made by stamping a single rod of metal material. The first connecting end 412 of the first terminal component 41 is welded or crimped to the second connecting end 422 of the second terminal component 42.

As shown in FIG. 5, the first mating end 411 of the first terminal component 41 includes a plurality of elastic arms 41a. The plurality of elastic arms 41a are spaced apart in a circumferential direction of the first terminal component 41 and are used for electrical contact with a first mating central terminal inserted into the first mating end 411.

A first noble metal plating is formed on an inner surface of the first mating end 411 of the first terminal component 41 to improve electrical contact performance between the first mating end 411 and the first mating central terminal. Since the electrical contact surface of the first mating end 411 of the first terminal component 41 is an inner surface, for convenience, in the illustrated embodiment, the first noble metal plating is brush-plated onto one side surface of the sheet of metal material before the sheet of metal material is rolled into the cylindrical shape. The first noble metal plating is a silver plating or a gold plating.

As shown in FIGS. 5-6, the second mating end 421 of the second terminal component 42 is columnar. The second mating end 421 is used for insertion into a second mating central terminal to establish electrical contact with the second mating central terminal. A second noble metal plating is formed on an outer surface of the second mating end 421 of the second terminal component 42 to improve electrical contact performance between the second mating end 421 and the second mating central terminal. The second noble metal plating is a silver plating or a gold plating.

As shown in FIGS. 5-6, the first terminal component 41 further includes a first body portion 410 located between the first mating end 411 and the first connecting end 412. A plurality of protrusions 41b, as shown in FIG. 6, are formed on an outer surface of the first body portion 410 of the first terminal component 41. The plurality of protrusions 41b are spaced apart in a circumferential direction of the first terminal component 41 and are used for interference fit with a central insertion hole 21 of an insulator 2, as shown in FIG. 2, in a coaxial connector to fix the central terminal 4 in the central insertion hole 21 of the insulator 2.

In the aforementioned exemplary embodiments according to the present invention, since the central terminal 4 is assembled from the stamped first terminal component 41 and the stamped second terminal component 42, the present invention can reduce the manufacturing costs of the central terminal 4 and improve the manufacturing efficiency of the central terminal 4.

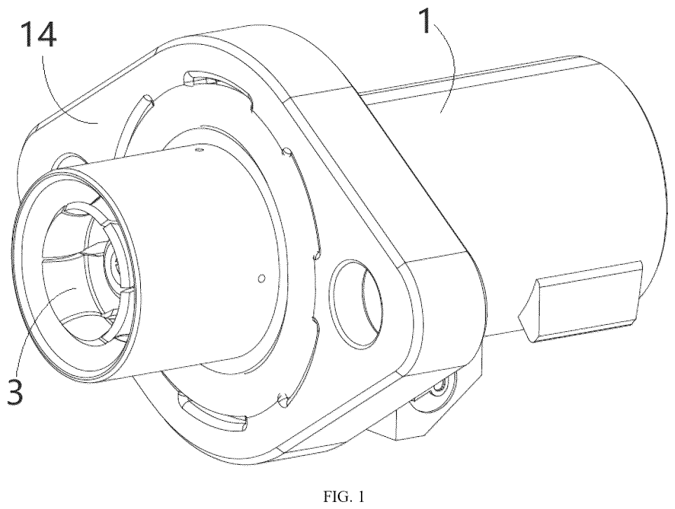

An exemplary embodiment of a coaxial connector will now be described with reference to FIGS. 1-7. As shown in FIG. 2, the coaxial connector includes a shield shell 1, an insulator 2, an outer terminal 3 and the central terminal 4 as described above. The insulator 2, as shown in FIG. 2, is formed with a central insertion hole 21 and is mounted in the shield shell 1. As shown in FIG. 2, the outer terminal 3 is disposed in the shield shell 1 and sleeved on the insulator 2, and the central terminal 4 is inserted and mounted into the central insertion hole 21 of the insulator 2.

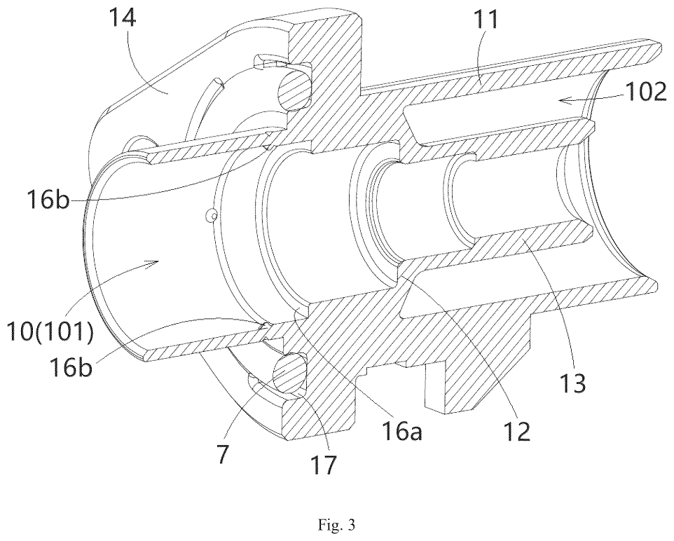

As shown in FIG. 3, the shield shell 1 includes an outer peripheral wall 11, a partition wall 12, and a mating cylinder 13. The outer peripheral wall 11 encloses an inner cavity 10. The partition wall 12 is connected to the outer peripheral wall 11 and divides the inner cavity 10 into a first chamber 101 and a second chamber 102. The mating cylinder 13 is located in the second chamber 102 and connected to the partition wall 12 for electrical contact with a second mating outer terminal inserted into the second chamber 102. The insulator 2 is inserted and mounted into the first chamber 101 of the shield shell 1, and the first terminal component 41 is inserted and mounted into the central insertion hole 21 of the insulator 2. The second terminal component 42, as shown in FIG. 2, extends from the insulator 2 and is inserted into the mating cylinder 13 to mate with a second mating central terminal inserted into the mating cylinder 13.

As shown in FIG. 5, the second terminal component 42 further includes a second body portion 420 located between the second connecting end 422 and the second mating end 421. The coaxial connector further includes a seal 5, as shown in FIG. 2, sleeved on the second body portion 420 of the second terminal component 42. The seal 5 is compressed radially between an inner peripheral surface of the mating cylinder 13 and an outer peripheral surface of the second body portion 420 to achieve sealing therebetween.

The outer terminal 3 is located in the first chamber 101 of the shield shell 1. As shown in FIG. 2, the outer terminal 3 includes a cylindrical body 30 and a plurality of cantilever portions 3a formed on one end of the cylindrical body 30. The plurality of cantilever portions 3a are spaced apart in a circumferential direction of the outer terminal 3 and are used for electrical contact with a first mating outer terminal inserted into the outer terminal 3. The other end of the cylindrical body 30 of the outer terminal 3 is sleeved on the insulator 2 and is in interference fit with the insulator 2 to fix the outer terminal 3 to the insulator 2.

As shown in FIG. 2, the coaxial connector further includes an elastic conductive ring 6 sleeved on the other end of the cylindrical body 30 of the outer terminal 3 and compressed radially between an inner wall surface of the shield shell 1 and the outer terminal 3 to electrically connect the outer terminal 3 to the shield shell 1. The elastic conductive ring 6 is C-shaped, such that the elastic conductive ring 6 is radially elastically deformed when squeezed. The present invention is not limited to the illustrated embodiment, and, for example, a ring-shaped conductive spring may be used instead of the elastic conductive ring 6.

As shown in FIG. 3, a positioning step 16a and a plurality of positioning protrusions 16b are formed in the shield shell 1. The plurality of positioning protrusions 16b are spaced apart in a circumferential direction of the shield shell 1 and are axially opposite the positioning step 16a. The elastic conductive ring 6 has two axially opposite sides, the plurality of positioning protrusions 16b are adapted to abut against one of the sides of the elastic conductive ring 6, and the positioning step 16a is adapted to abut against the other side of the elastic conductive ring 6, so as to axially position the elastic conductive ring 6. The positioning protrusions 16b may be formed by stamping the outer peripheral wall 11 of the shield shell 1.

A flange portion 14, as shown in FIGS. 1 and 3, for mounting to a mounting panel is formed on an outer side of the shield shell 1, and a sealing ring mounting groove 17, as shown in FIG. 3, is formed on a side of the flange portion 14 facing the mounting panel. As shown in FIG. 3, the coaxial connector further includes a sealing ring 7 mounted in the sealing ring mounting groove 17 of the flange portion 14. The sealing ring 7 is adapted to be compressed axially between the mounting panel and the flange portion 14 to achieve sealing therebetween.

An exemplary embodiment of a connector assembly will now be described with reference to FIGS. 1-7. The connector assembly includes the coaxial connector as described above, a first mating connector, and a second mating connector. The first mating connector mates with one end of the coaxial connector. The second mating connector mates with another end of the coaxial connector. The first mating connector includes a first mating central terminal and a first mating outer terminal respectively mating with the first mating end 411 of the central terminal 4 and the outer terminal 3 of the coaxial connector. The second mating connector includes a second mating central terminal and a second mating outer terminal respectively mating with the second mating end 421 of the central terminal 4 and the mating cylinder 13 of the shield shell 1 of the coaxial connector.

An exemplary embodiment of a terminal manufacturing method for manufacturing a central terminal 4 will now be described. The terminal manufacturing method includes a step S1: manufacturing the first terminal component 41 and a first conveying tape 81 connected to the first terminal component 41 by stamping a single sheet of metal material; a step S2: manufacturing the second terminal component 42 by stamping a single rod of metal material, manufacturing a second conveying tape by stamping a metal sheet, and assembling the second terminal component 42 to the second conveying tape; a step S3: continuously conveying the first terminal component 41 and the second terminal component 42 to a terminal assembly apparatus by a conveying mechanism engaging with positioning holes 8a in the first conveying tape 81 and a second conveying tape; and a step S4: assembling the first terminal component 41 and the second terminal component 42 together by the terminal assembly apparatus to form the central terminal 4.

A clamping structure suitable for clamping the second terminal component 42 is formed on the second conveying tape. Thus, the second terminal component 42 can be assembled to the second conveying tape with the clamping structure, so that the second terminal component 42 can be continuously conveyed to the plating device and the terminal assembly apparatus by the second conveying tape. In this way, the manufacturing efficiency of the central terminal 4 can be significantly improved.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A central terminal, comprising:
a first terminal component having a cylindrical shape, a first mating end, and a first connecting end axially opposite the first mating end; and
a second terminal component having a columnar shape, a second mating end, and a second connecting end axially opposite the second mating end, the second connecting end is inserted into and connected to the first connecting end, the first terminal component is an integrated stamped part made by stamping a single sheet of metal material, and the second terminal component is an integrated stamped part made by stamping a single rod of metal material.

2. The central terminal of claim 1, wherein the first connecting end is welded or crimped to the second connecting end.

3. The central terminal of claim 1, wherein the first mating end has a plurality of elastic arms, the plurality of elastic arms are spaced apart in a circumferential direction of the first terminal component and electrically contact a first mating central terminal inserted into the first mating end.

4. The central terminal of claim 3, wherein a first noble metal plating is formed on an inner surface of the first mating end, the first noble metal plating improves an electrical contact performance between the first mating end and the first mating central terminal.

5. The central terminal of claim 4, wherein the first noble metal plating is brush-plated onto one side surface of the sheet of metal material before the sheet of metal material is rolled into the cylindrical shape.

6. The central terminal of claim 4, wherein the first noble metal plating is a silver plating or a gold plating.

7. The central terminal of claim 3, wherein the second mating end is columnar and is inserted into a second mating central terminal to establish electrical contact with the second mating central terminal.

8. The central terminal of claim 7, wherein a second noble metal plating is formed on an outer surface of the second mating end, the second noble metal plating improves an electrical contact performance between the second mating end and the second mating central terminal.

9. The central terminal of claim 8, wherein the second noble metal plating is a silver plating or a gold plating.

10. The central terminal of claim 1, wherein the first terminal component further has a first body portion between the first mating end and the first connecting end, a plurality of protrusions are formed on an outer surface of the first body portion, the plurality of protrusions are spaced apart in a circumferential direction of the first terminal component and are interference fit with a central insertion hole of an insulator in a coaxial connector to fix the central terminal in the central insertion hole.

11. A coaxial connector, comprising:
a shield shell;
an insulator formed with a central insertion hole and mounted in the shield shell;
an outer terminal disposed in the shield shell and sleeved on the insulator; and
a central terminal including a first terminal component and a second terminal component,
the first terminal component has a cylindrical shape, a first mating end, and a first connecting end axially opposite the first mating end, the second terminal component has a columnar shape, a second mating end, and a second connecting end axially opposite the second mating end, the second connecting end is inserted into and connected to the first connecting end, the first terminal component is an integrated stamped part made by stamping a single sheet of metal material, and the second terminal component is an integrated stamped part made by stamping a single rod of metal material, the central terminal is inserted and mounted into the central insertion hole.

12. The coaxial connector of claim 11, wherein the shield shell has an outer peripheral wall, a partition wall, and a mating cylinder, the outer peripheral wall encloses an inner cavity, the partition wall is connected to the outer peripheral wall and divides the inner cavity into a first chamber and a second chamber, the mating cylinder in the second chamber and connected to the partition wall electrically contacts a second mating outer terminal inserted into the second chamber, the insulator is inserted and mounted into the first chamber, and the first terminal component is inserted and mounted into the central insertion hole, the second terminal component extends from the insulator and is inserted into the mating cylinder to mate with a second mating central terminal inserted into the mating cylinder.

13. The coaxial connector of claim 12, wherein the second terminal component further has a second body portion between the second connecting end and the second mating end, and the coaxial connector further has a seal sleeved on the second body portion, the seal is compressed radially between an inner peripheral surface of the mating cylinder and an outer peripheral surface of the second body portion to achieve sealing therebetween.

14. The coaxial connector of claim 12, wherein the outer terminal is in the first chamber, the outer terminal has a cylindrical body and a plurality of cantilever portions formed on one end of the cylindrical body, the plurality of cantilever portions are spaced apart in a circumferential direction of the outer terminal and electrically contact a first mating outer terminal inserted into the outer terminal.

15. The coaxial connector of claim 14, wherein an other end of the cylindrical body of the outer terminal is sleeved on the insulator and is interference fit with the insulator to fix the outer terminal to the insulator.

16. The coaxial connector of claim 15, further comprising an elastic conductive ring sleeved on the other end of the cylindrical body of the outer terminal and compressed radially between an inner wall surface of the shield shell and the outer terminal to electrically connect the outer terminal to the shield shell.

17. The coaxial connector of claim 16, wherein the elastic conductive ring is C-shaped.

18. The coaxial connector of claim 16, wherein a positioning step and a plurality of positioning protrusions are formed in the shield shell, the plurality of positioning protrusions are spaced apart in a circumferential direction of the shield shell and are axially opposite the positioning step, the elastic conductive ring has two axially opposite sides, the plurality of positioning protrusions abut against one of the sides of the elastic conductive ring, and the positioning step abuts against an other side of the elastic conductive ring, so as to axially position the elastic conductive ring.

19. The coaxial connector of claim 11, wherein a flange portion mounting to a mounting panel is formed on an outer side of the shield shell, a sealing ring mounting groove is formed on a side of the flange portion facing the mounting panel, and the coaxial connector further has a sealing ring mounted in the sealing ring mounting groove, the sealing ring is compressed axially between the mounting panel and the flange portion to achieve sealing therebetween.

20. A terminal manufacturing method, comprising:
manufacturing a first terminal component of a central terminal and a first conveying tape connected to the first terminal component by stamping a single sheet of metal material;
manufacturing a second terminal component of the central terminal by stamping a single rod of metal material;
manufacturing a second conveying tape by stamping a metal sheet;
assembling the second terminal component to the second conveying tape;
continuously conveying the first terminal component and the second terminal component to a terminal assembly apparatus by a conveying mechanism engaging with positioning holes in the first conveying tape and the second conveying tape; and
assembling the first terminal component and the second terminal component together with the terminal assembly apparatus to form the central terminal.
